(19) United States
(12) Patent Application Publication
(10) Pub. No.: US 2019/0347006 A1
(43) Pub. Date: Nov. 14, 2019

(54) METHOD OF SYSTEM INFORMATION PROGRAMMING FOR A DATA STORAGE APPARATUS AND A CORRESPONDING METHOD OF SYSTEM INFORMATION RE-BUILDING

(71) Applicant: Silicon Motion, Inc., Zhubei City (TW)

(72) Inventors: Huan-Jung YEH, Zhubei City (TW); Ching-Ke CHEN, Zhubei City (TW)

(73) Assignee: Silicon Motion, Inc., Zhubei City (TW)

(21) Appl. No.: 16/411,967

(22) Filed: May 14, 2019

(30) Foreign Application Priority Data
May 14, 2018 (TW) 107116350
Jun. 13, 2018 (TW) 107120420

(51) Int. Cl. G06F 3/06

(52) U.S. Cl. CPC G06F 3/0604; G06F 3/0679; G06F 3/0635

(57) ABSTRACT

A method of system information programming for a data storage apparatus is provided. Whether a system information is a block linking table is determined. In response to the determination that the system information is the block linking table, a part of the system information is programmed to a head big page in a system block including a number of big pages, rest of the system information is programmed to at least one of the big pages in the system block, and a recording table is programmed to a tail big page in the system block. In response to the determination that the system information is not the block linking table, the system information is programmed to at least one of the big pages in the system block, and the recording table is programmed to the tail big page in the system block.

This application claims the benefit of Taiwan application Serial No. 107116350, filed May 14, 2018 and Taiwan application Serial No. 107120420, filed Jun. 13, 2018 the subject matter of which is incorporated herein by reference.

### BACKGROUND OF THE DISCLOSURE

### Field of the Disclosure

The disclosure relates in general to a data storage apparatus, a system information programming method, and a system information re-building method.

### Description of the Related Art

Along with the advance in the manufacturing technology of memory, the unit storage capacity of the memory is getting larger and larger. In recent years, the internal structure of the memory is directed towards the trend of increasing the storage capacity of each block but decreasing the total amount of blocks. In other words, the memory is directed towards the trend of less blocks but larger block capacity.

Generally speaking, the memory of a manufactured data storage apparatus stores many apparatus information, for example, mapping information, linking information, and logical to physical (L2P) mapping table. Under the current block configuration of the memory, in order to maintain the apparatus information and secure the reliability, different management, update, and rebuild methods are required.

### SUMMARY OF THE DISCLOSURE

The disclosure is directed to a method of system information programming for a data storage apparatus and a corresponding method of system information re-building.

According to one embodiment of the disclosure, a method of system information programming for a data storage apparatus is disclosed. The method includes the following steps. Whether a system information is a block linking table is determined. In response to the determination that the system information is the block linking table, a part of the system information is programmed to a head big page in a system block including a number of big pages, rest of the system information is programmed to at least one of the big pages in the system block, and a recording table is programmed to a tail big page in the system block. In response to the determination that the system information is not the block linking table, the system information is programmed to at least one of the big pages in the system block, and the recording table is programmed to the tail big page in the system block.

According to another embodiment of the disclosure, a method of system information re-building is disclosed. The method of system information re-building includes the following steps. A number of big pages of a system block are reversely scanned to obtain a valid big page. A scan page count is recorded. Whether the valid big page is a head big page and the scan page count is not greater than a total amount of big pages required for storing a block linking table is determined. When the determination is true, a linking flag is changed to a second value from a first value. When the determination is false, whether the scan page count is greater than the total amount of big pages required for storing the block linking table and the linking flag is the first value is determined. When the determination of whether the scan page count is greater than the total amount of big pages required for storing the block linking table and the linking flag is the first value is true, the block linking table is re-built.

The method of system information programming for a data storage apparatus and the corresponding method of system information re-building of the disclosure are capable of more accurately determining whether the block linking table and the mapping information table need to be re-built. The mapping information table takes a large amount of time and system resources to re-build. The disclosure can reduce the error in determining whether the mapping information table needs to be re-built, and therefore increase the overall efficiency of the data storage apparatus.

The above and other aspects of the disclosure will become better understood with regards to the following detailed description of the preferred but non-limiting embodiment (s). The following description is made with reference to the accompanying drawings.

### BRIEF DESCRIPTION OF THE DRAWINGS

FIG. 1 is a schematic diagram of a data storage apparatus according to an embodiment of the disclosure.

FIG. 2A is a block diagram of a data storage apparatus according to another embodiment of the disclosure.

FIG. 2B is a schematic diagram of big pages according to an embodiment of the disclosure.

FIG. 3A is a flowchart of a system information programming method according to an embodiment of the disclosure.

FIG. 3B is a schematic diagram of performing a system information programming process according to an embodiment of the disclosure.

FIG. 3C is a flowchart of a system information re-building method according to an embodiment of the disclosure.

FIG. 3D is an example of performing a system information re-building process according to an embodiment of the disclosure.

FIG. 3E is another example of performing a system information re-building process according to an embodiment of the disclosure.

### DETAILED DESCRIPTION OF THE DISCLOSURE

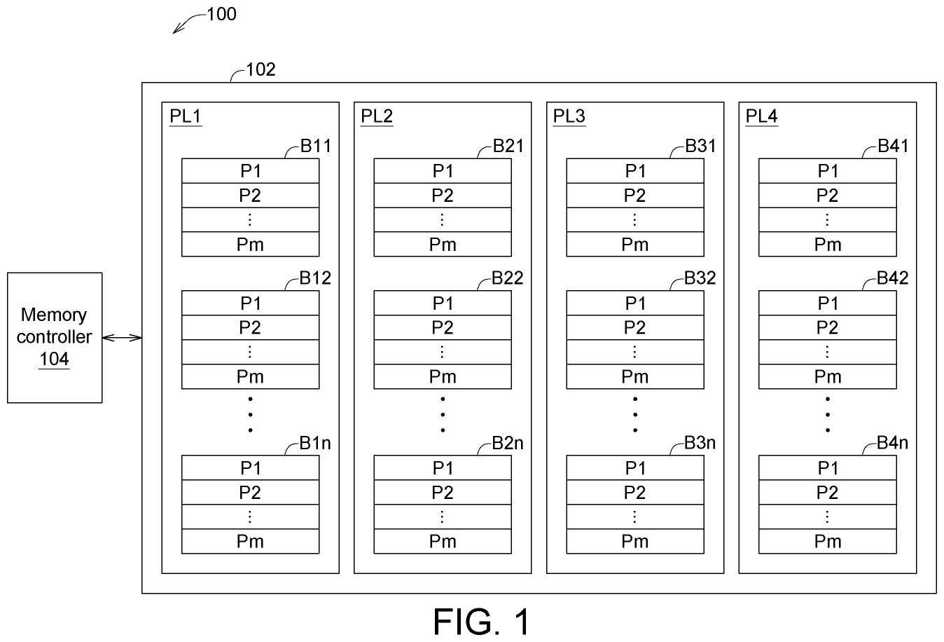

Referring to FIG. 1, a block diagram of a data storage apparatus according to an embodiment of the disclosure is shown. The data storage apparatus 100 mainly includes a non-volatile memory 102 and a memory controller 104, and the data storage apparatus 100 may further include a volatile memory to temporarily store the user data or the firmware or the logical to physical (L2P) mapping table required for the operation of the memory controller 104. The memory controller 104 is coupled to the non-volatile memory 102, and can perform the system information programming method disclosed in the embodiments of the disclosure.

The data storage apparatus 100 can further be coupled to a host (not shown). The host can output a data access (read or write) instruction to the data storage apparatus 100 to access (read or write) user data of the data storage apparatus 100. For example, the memory controller 104 of the data storage apparatus 100 can read data from one or more than one physical address of the non-volatile memory 102 in response to a read data instruction outputted from the host. The host can be, for example, a personal computer, a mobile phone, a PC tablet, an on-board unit, or a navigation device.

The non-volatile memory 102 can be a NAND flash memory. The memory controller 104 can be implemented as one or more than one control chip capable of transceiving data and instructions to or from the non-volatile memory 102 to perform operation to non-volatile memory 102, for example, to read, program, or erase the non-volatile memory 102.

The non-volatile memory 102 preferably has one or more than one logical unit number (LUN), which can be selected/enabled by a chip enable (CE) signal. Each logical unit number (LUN) includes, for example, 4 planes, namely, planes PL1-PL4. Each of the planes PL1-PL4 includes, for example, 2048 blocks, namely, blocks Bk1-Bkn, wherein k=1, 2, 3, 4, n=2048. Each of the blocks Bk1-Bkn includes, for example, 1024 pages, namely, pages P1-Pm, wherein m=1024. Each page can be controlled by a word line, and each word line can control more than one page. A page includes, for example, 16768B of data storage space, and can be divided into 16 KB data areas and 384 B spare areas. The data areas can store data (user data or system information). The spare areas can store the metadata of data. Besides, the memory cells on the word line can be quad level cells (QLC), triple level cells (TLC), multiple level cells (MLC) or single level cells (SLC). It should be noted that the present embodiment is for exemplary purpose only, and the amount of chips, planes, blocks, pages, word lines, and memory cells can be designed and configured according to actual needs.

Assume each LUN includes 4 planes. For the efficiency of the data storage apparatus 100 to be maximized, when writing data, the memory controller 104 normally writes the data to the non-volatile memory 102 by performing an inter-leaving programming process. During the inter-leaving programming process, the time of programming the data to the blocks (pages of the blocks) on all planes can be saved. For example, with 4 items of data being inter-leaving programmed to the block B11 on the plane PL1, the block B21 on the plane PL2, the block B31 on the plane PL3, and the block B41 on the plane PL4 at the same time, the time for programming 3 items of data can be saved. Thus, the inter-leaving programming can provide a higher data write speed.

The system information of the data storage apparatus 100 is, for example, system specification, operating parameter, mapping information table, block linking table, bad block information, block attribute table (recording, for example, erase count or valid page amount), or debugging information table (for example, SMART information table). The mapping information table is also referred as advanced mapping information, which records the address information of each sub-L2P mapping table of the L2P mapping table. Unlike the user data, the default (or maximum) size of the system information may not be identical. For example, the block linking table has a size of 380 KB, the mapping information table has a size of 90 KB, and the bad block information has a size of 4 KB. In the said system information. The block linking table (or referred as the linking table) records the order in which each block is used, and normally is updated when the end of block (EOB) information is written to any block. To improve the data storage ability, the memory controller 104 preferably performs the system information programming in a non-predetermined mode or an SLC mode. When the system information programming is performing in the SLC mode, a word line can control only one page. Also, for the convenience of managing different types of system information, the memory controller 104 normally uses one block to record one type of system information. If there are 10 types of system information to record, the memory controller 104 normally uses 10 blocks to record the system information respectively.

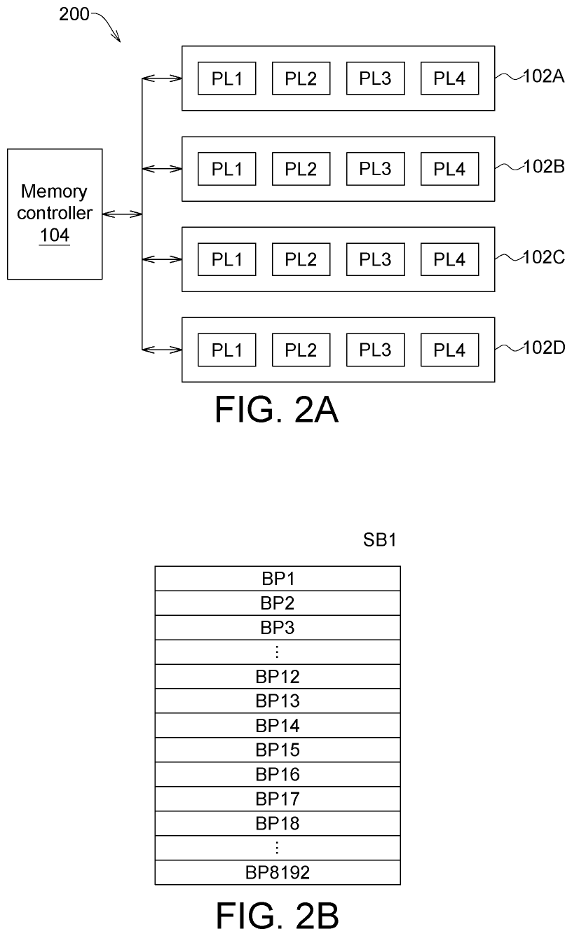

Referring to FIG. 2A, a block diagram of a data storage apparatus according to another embodiment of the disclosure is shown. The non-volatile memory of the data storage apparatus 200 may include 4 LUNs 102A-102D and the memory controller 104. Each of the LUNs 102A-102D has a structure identical to or similar with the structure of the non-volatile memory 102. Each of the LUNs 102A-102D can be linked to the memory controller 104 through an independent channel, and the memory controller 104 can enable the LUNs 102A-102D using the same or different chip enabling signals to access data.

Under a four-channel architecture, the memory controller 104 can parallelly access the LUNs 102A-102D, and the data throughput of the data storage apparatus 200 is 4 times than the data throughput of the data storage apparatus 100. Under the four-channel architecture, the memory controller 104 can select a block from each plane of each LUN to generate a super block, and the selected block is also referred as a member block. For example, the blocks B11-B41 on the planes PL1-PL4 of each of the LUNs 102A-102D are selected by the memory controller 104 to generate a super block SB1, and the rest can be obtained by the same way. Meanwhile, the memory controller 104 can use a super block to record one type of system information. If there are 10 types of system information to record, the memory controller 104 will normally use 10 super blocks to record the system information respectively. In comparison to the access of one single block, the access of the super block has a higher efficiency. Therefore, the explanations below will be exemplified by the super block, but the disclosure is not limited thereto.

Along with the advance in the technology of the non-volatile memory 102, although the block amount of the non-volatile memory 102 may not increase, the page amount in each block continues to grow such that the data storage capacity of the non-volatile memory 102 can be increased. If the memory controller 104 still uses 10 super blocks to record the system information, the system information will occupy too much data storage space of the non-volatile memory 102.

To reduce the data storage capacity occupied by the system information, different types of system information are stored to the same super block, for example, the super block SB1. To further reduce the data storage capacity occupied by the system information, the super block SB1 can be divided into a number of small blocks according to a plane amount parameter. Let the plane amount parameter be exemplified by 2. Of the super block SB1, the blocks B11-B21 on the planes PL1-PL2 of the LUN 102A are set as the first small block, the blocks B31-B41 on the planes PL3-PL4 of the LUN 102A are set as the second small block, and the blocks B31-B41 on the planes PL3-PL4 of the LUN 102D are set as the 8-th small block. Then, the pages on different planes of each small block are combined to form a number of big pages according to a page or plane orientation. Thus, the super block SB1 will include 8192 big pages, namely, big pages BP1-BP8192, as indicated in FIG. 2B. If the data area of each page on a plane has a size of 16 KB, then the data area of a big page has a size of 32 KB. By using the big pages as the storage unit of the system information, not only the efficiency of data storage is increased, but also the data storage space is reduced.

Since different types of system information are all stored to the super block SB1, during the process of programming the system information to the super block SB1, if the operation is interrupted accidently (for example, power interruption), the data stored in some of the big pages will be lost and the system information will become incomplete and needs to be re-built. However, it takes a large amount of time to re-build the mapping information table of the system information and the block linking table. Therefore, the disclosure discloses a system information re-building method, which, when used in combination with the system information programming method of this disclosure, is capable of determining the completeness of the system information to determine whether the mapping information table or the block linking table needs to be re-built after the accident interruption occur. Thus, the system information can be re-built more effectively, and will not be re-built when the re-building of system information is not necessary, hence saving unnecessary waste of time.

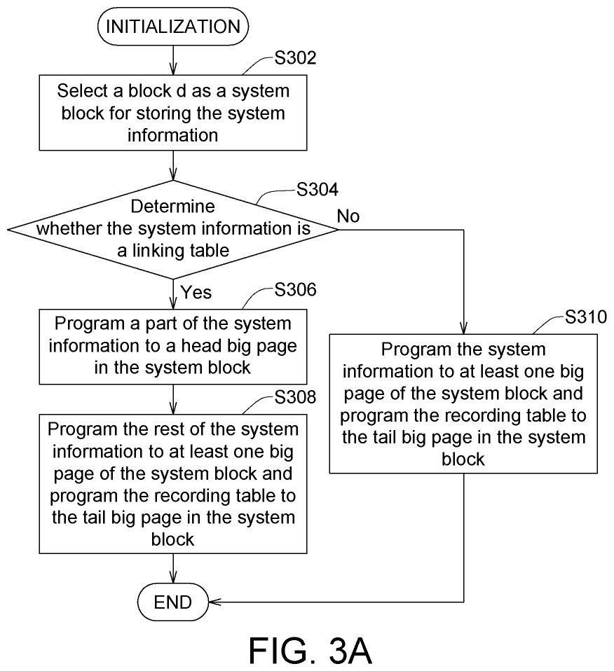

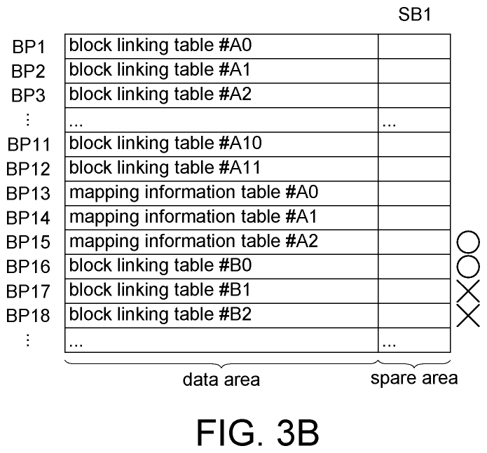

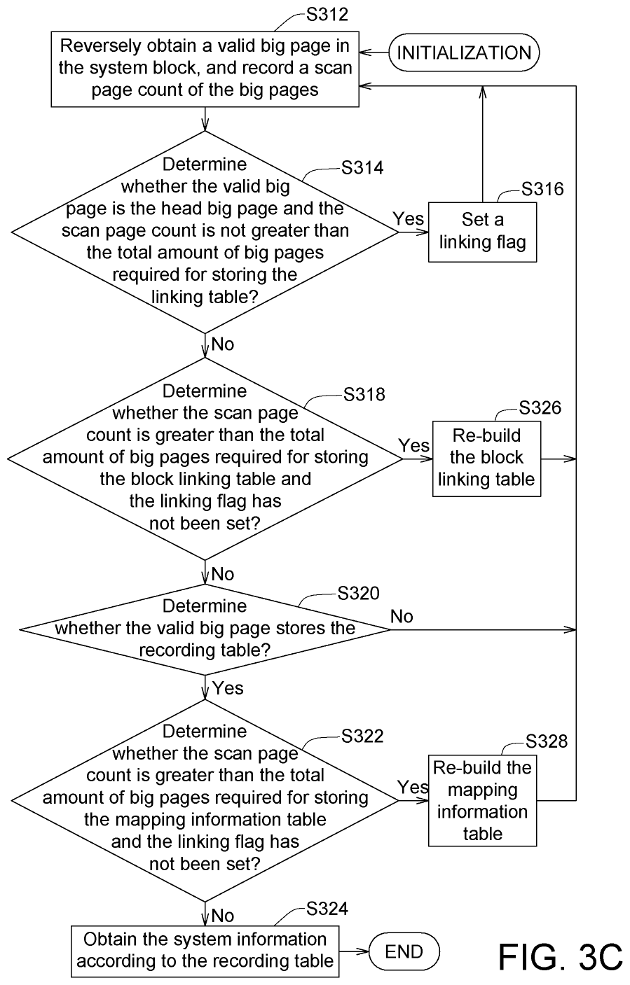

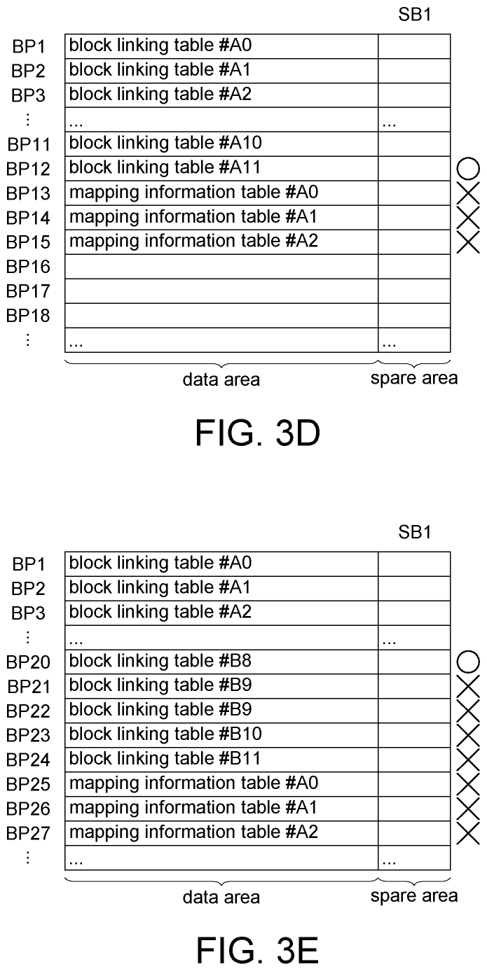

Referring to FIG. 3A, a flowchart of a system information programming method according to an embodiment of the disclosure is shown. In step S302, a block is selected as a system block for storing the system information by the memory controller 104. For example, the memory controller 104 selects the super block SB1 as the system block for storing the system information.

In step S304, whether the system information is a linking table is determined by the memory controller 104. The memory controller 104 determines whether the system information is a block linking table according to a system information code, a length or other flag of the system information. If the determination in step S304 is true, the method proceeds to step S306; otherwise, the method proceeds to step S310.

In step S306, a part of the system information is programmed to the head big page in the system block by the memory controller 104. If the block linking table has a size of 380 KB and each big page has a size of 32 KB, then the block linking table needs to be programmed to 12 big pages (the linking page amount is equivalent to 12). The memory controller 104 uses the first big page of the 12 big pages as the head big page, and the 12-th big page as the tail big page. The memory controller 104 only programs a part of the block linking table to the head big page. As indicated in FIG. 3B, the memory controller 104 only programs the block linking table #A0 of the block linking table #A to the big page BP1 (the head big page) of the super block SB1. Also, after performing data programming, the memory controller 104 preferably reads the content of the big page BP1 to confirm whether the block linking table #A0 has been programmed to the big pages BP1.

In step S308, the rest of the system information is programmed to at least one big page of the system block by the memory controller 104 and the recording table is programmed to the tail big page in the system block by the memory controller 104. Under the four-channel architecture, the rest block linking tables of the block linking table #A can be parallelly programmed to a number of big pages in the system block by the memory controller 104. For example, first of all, the block linking tables #A1-A7 are parallelly programmed to the big pages BP2-BP8, and then the block linking tables #A8-A11 are parallelly programmed to the big pages BP9-BP12 to complete the storage of the block linking table #A. Meanwhile, the memory controller 104 simultaneously programs the block linking table #A11 and the recording table to the big page BP12 (the tail big page). The block linking table #A11 is preferably programmed to the data area of the big page BP12, and the recording table is preferably programmed to the spare area of the big page BP12.

The recording table preferably records the system information code and the storage address of the system information. For example, the system information has 5 types, and the corresponding system information codes are A-E. When the block linking table is stored to the big pages BP1-BP12 of the super block, the storage address of the block linking table is updated as the big pages BP1 from the default value “FF”. The record table is as below:

| Type of System | System | Storage | Big Page |
|---|---|---|---|
| Information | Information Code | Address | Amount |
| System | A | FF | 1 |
| Specifications | | | |
| Operating | B | FF | 1 |
| Parameters | | | |
| Mapping | C | FF | 3 |
| Information Table | | | |
| Block Linking | D | BP1 | 12 |
| Table | | | |
| Bad block | E | FF | 1 |
| Information | | | |

The recording table can further record the total amount of big pages occupied by each type of system information.

In step S310, the system information and the recording table are respectively programmed to at least one big page of the system block and the tail big page in the system block by the memory controller 104. If the system information is the mapping information table #A which has a size of 90 KB and each big page has a size of 32 KB, then the memory controller 104 will program the mapping information tables #A0-A2 to 3 big pages, that is, BP13-BP15, of the system block, and program the updated recording table to the big page BP15. The updated recording table is as below:

| Type of System | System | Storage | Big Page |
|---|---|---|---|
| Information | Information Code | Address | Amount |
| System | A | FF | 1 |
| Specifications | | | |
| Operating | B | FF | 1 |
| Parameters | | | |
| Mapping | C | BP13 | 3 |
| Information Table | | | |
| Block Linking | D | BP1 | 12 |
| Table | | | |
| Bad block | E | FF | 1 |
| Information | | | |

If the block linking table is updated, then the memory controller 104 will again perform step S304 to program the block linking table #BO to the head big page, that is, the big page BP16, and then perform step S306 to program the block linking tables #B1-B11 to the big pages BP17-BP27 and program the recording table to the big pages BP27.

During the process of programming the block linking table #B1-B11 to the big pages BP17-BP27 by the memory controller 104, if power interruption occurs, the block linking tables #B1-B2 cannot be successfully programmed to the big pages BP17-BP18, and the programming method has not yet been performed to the block linking tables #B3-B11. After power interruption is over, the memory controller 104 performs the system information re-building method of the disclosure as indicated in FIG. 3C to re-build the system information.

In step S312, the valid big page in the system block is reversely obtained and the scan page count of the big page is recorded by the memory controller 104. The memory controller 104 reads the content of each big page from the last big page in the system block toward the big page BP1. If a big page, for example, the big page BP19, does not store data, then the content of this big page is the same as the default value (for example, FFFF,FFFF). If data cannot be successfully programmed to the big pages, for example, the big pages BP17-BP18, then the content of the big pages normally cannot be corrected by using an error correction code (ECC), and such big pages are determined as invalid big pages (designated as “X”). If data can be successfully programmed to the big pages, for example, the big page BP16, then the content of the big page can be corrected by using ECC and can be read, and such big pages are determined as valid big pages (designated as “O”). In the example of FIG. 3C, the valid big page is the big page BP16. Here, “reversely” refers to the direction opposite to the order in which the big pages are programmed. For example, if the big pages are sequentially programmed from BP1 towards BP8192, then the big pages are scanned in order from BP8192 to BP1 (that is, reversely). In the present embodiment, the memory controller 104 programs the big pages in a first order and scans the big pages in a second order. The second order is inverse to the first order.

In step S314, whether the valid big page is the head big page and the scan page count is not greater than the total amount of big pages required for storing the linking table is determined by the memory controller 104. Meanwhile, the big page BP16 is exactly the head big page storing the block linking table #B, and the scan page count (equivalent to 3) is not greater than the total amount of big pages (equivalent to 12) required for storing the block linking table. Therefore, if it is determined that the determination in step S314 is true, the method proceeds to step S316. If the determination in step S314 is false, the method proceeds to step S318.

In step S316, a linking flag is set by the memory controller 104, that is, the memory controller 104 changes the value of the linking flag to a second value (for example, “1”) from a first value (for example, “0”). Then, step S312 is performed again. In step S312, the next valid big page, that is, the big page BP15 being the tail big page storing the mapping information table #A, is obtained by the memory controller 104, and the value of the scan page count is increased to 4. Since the big pages BP15 is not the head big page, the determination in step S314 is false, and the method proceeds to step S318.

In step S318, whether the scan page count is greater than the total amount of big pages required for storing the block linking table and the linking flag has not been set (that is, the value of the linking flag is still the first value) is determined by the memory controller 104. Since the scan page count (equivalent to 4) is not greater than the total amount of big pages (equivalent to 12) required for storing the block linking table, the determination in step S318 is false, and the method proceeds to step S320.

In step S320, whether the valid big page stores the recording table is determined by the memory controller 104. Since the big page BP15 is the tail big page storing the mapping information table #A and stores the recording table, the determination in step S320 is true, and the method proceeds to step S322.

In step S322, whether the scan page count is greater than the total amount of big pages required for storing the mapping information table and the linking flag has not been set is determined by the memory controller 104. If the determination in step S322 is true, the method proceeds to step S328. If the determination in step S322 is false, the method proceeds to step S324. Meanwhile, the scan page count (equivalent to 4) is greater than the total amount of big pages (equivalent to 3) required for storing the mapping information table, and this indicates that invalid big pages may store the mapping information table. Since the linking flag is already set, invalid big pages do not store the mapping information table but store other content of the block linking table #B instead. Since the update (the block linking table #B) of the block linking table is not completed due to power interruption, the block linking table #A still has the most updated block linking table, and there is no need to re-build the mapping information table or the block linking table.

In step S324, the system information is obtained by the memory controller 104 according to the recording table obtained in step S320. The memory controller 104 can read the recording table to obtain the storage address of the block linking table #A and then accordingly obtain the updated block linking table (the block linking table #A). Also, the memory controller 104 can read the recording table to obtain the storage address of other types of system information and further obtain other types of system information accordingly to achieve the purpose of the disclosure.

Under another circumstance as indicated in FIG. 3D, the valid big page obtained in step S312 is the big page BP12, all of the big pages BP13-BP15 are invalid big pages, and the scan page count is 4. Since the determination in step S314 is false, there is no need to set the linking flag. Then, since the determination in step S318 is false but the determination in step S320 is true, the memory controller 104 obtains the recording table from the big page BP12. Since the scan page count (equivalent to 4) is greater than the total amount of big pages (equivalent to 3) for storing the mapping information table and the linking flag has not been set, the determination in step S322 is true and indicates that the big pages BP13-BP18 may store the mapping information table, the method proceeds to step S328. In step S328, the mapping information table (the mapping information table #A) is re-built by the memory controller 104.

Under another circumstance as indicated in FIG. 3E, all of the big pages BP21-BP27 are invalid big pages, and the big page BP20 is a valid big page. Since the big pages BP20 does not store the recording table, the memory controller 104 reversely obtains the next valid big page, that is, the big page BP19, and the rest can be obtained by the same way. When the memory controller 104 obtains the valid big page BP15, the scan page count is already increased to 13 and greater than the total amount of big pages (equivalent to 12) required for storing the block linking table and the linking flag has not been set, the method proceeds to step S326. In step S326, the block linking table #B is re-built by the memory controller 104. Then, the memory controller 104 determines the valid big page BP13 is the head big page, and the recording table is obtained in the valid big page BP12. Since the scan page count is already increased to 16 and greater than the total amount of big pages (equivalent to 3) required for storing the mapping information table and the linking flag has not been set, the method proceeds to step S328 and the mapping information table #A is re-built by the memory controller 104. Lastly, the memory controller 104 again obtains the storage address of other types of system information according to the recording table to obtain other types of system information.

It should be noted that the mapping information table or the block linking table can be re-built using any method generally known to anyone ordinarily skilled in the art, and the disclosure does not have specific restrictions.

According to another embodiment of the disclosure, a method of system information programming for a data storage apparatus is provided. The method includes the following steps. Whether a system information is a block linking table is determined. In response to the determination that the system information is the block linking table, a part of the system information is programmed to a head big page in a system block including a number of big pages, rest of the system information is programmed to at least one of the big pages in the system block, and a recording table is programmed to a tail big page in the system block. In response to the determination that the system information is not the block linking table, the system information is programmed to at least one of the big pages in the system block, and the recording table is programmed to the tail big page in the system block.

The above method further includes reading content of the head big page, the big pages, and the tail big page to confirm whether the system information is programmed successfully. The system information is determined as the block linking table according to a system information code, a length, or a flag of the system information. The head big page, the big pages, and the tail big page are programmed sequentially or the head big page, the big pages, and the tail big page are programmed in order.

According to further another embodiment of the disclosure, a method of system information re-building is provided. The method of system information re-building includes the following steps. A number of big pages of a system block are reversely scanned to obtain a valid big page. A scan page count is recorded. Whether the valid big page is a head big page and the scan page count is not greater than a total amount of big pages required for storing a block linking table is determined. When the determination is true, a linking flag is changed to a second value from a first value. When the determination is false, whether the scan page count is greater than the total amount of big pages required for storing the block linking table and the linking flag is the first value is determined. When the determination of whether the scan page count is greater than the total amount of big pages required for storing the block linking table and the linking flag is the first value is true, the block linking table is re-built.

The above method of system information re-building further includes the following steps. When the determination that the scan page count is greater than the total amount of big pages required for storing the block linking table and the linking flag is the first value is false, whether the valid big page stores a recording table, the scan page count is greater than the total amount of big pages required for storing a mapping information table, and the linking flag is the first value is determined. When the determination of whether the valid big page stores a recording table, the scan page count is greater than the total amount of big pages required for storing a mapping information table, and the linking flag is the first value is true, the mapping information table is re-built. When the determination that the valid big page stores the recording table, the scan page count is greater than the total amount of big pages required for storing the mapping information table, and the linking flag is the first value is false, the system information is obtained according to the recording table.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of system information programming for a data storage apparatus, comprising:
determining whether a system information is a block linking table;
in response to the determination that the system information is the block linking table, programming a part of the system information to a head big page in a system block comprising a plurality of big pages, programming rest of the system information to at least one of the big pages in the system block, and programming a recording table to a tail big page in the system block; and
in response to the determination that the system information is not the block linking table, programming the system information to at least one of the big pages in the system block, and programming the recording table to the tail big page in the system block.

2. The method of system information programming according to claim 1, further comprising:
reading content of the head big page, the big pages, and the tail big page to confirm whether the system information is programmed successfully.

3. The method of system information programming according to claim 1,
wherein the system information is determined as the block linking table according to a system information code, a length, or a flag of the system information.

4. The method of system information programming according to claim 1,
wherein the head big page, the big pages, and the tail big page are programmed sequentially.

5. The method of system information programming according to claim 1,
wherein the head big page, the big pages, and the tail big page are programmed in order.

6. A method of system information re-building, comprising:
reversely scanning a plurality of big pages of a system block to obtain a valid big page;
recording a scan page count;
determining whether the valid big page is a head big page and the scan page count is not greater than a total amount of big pages required for storing a block linking table;
when the determination is true, changing a linking flag to a second value from a first value;
when the determination is false, determining whether the scan page count is greater than the total amount of big pages required for storing the block linking table and the linking flag is the first value; and
when the determination of whether the scan page count is greater than the total amount of big pages required for storing the block linking table and the linking flag is the first value is true, re-building the block linking table.

7. The method of system information re-building according to claim 6, further comprises:
when the determination that the scan page count is greater than the total amount of big pages required for storing the block linking table and the linking flag is the first value is false, determining whether the valid big page stores a recording table, the scan page count is greater than the total amount of big pages required for storing a mapping information table, and the linking flag is the first value; and
when the determination of whether the valid big page stores a recording table, the scan page count is greater than the total amount of big pages required for storing a mapping information table, and the linking flag is the first value is true, re-building the mapping information table.

8. The method of system information re-building according to claim 7, further comprising:
when the determination that the valid big page stores the recording table, the scan page count is greater than the total amount of big pages required for storing the mapping information table, and the linking flag is the first value is false, obtaining the system information according to the recording table.
